(19) United States
(12) Patent Application Publication
(10) Pub. No.: US 2012/0238114 A1
(43) Pub. Date: Sep. 20, 2012

(54) Card Connector

(76) Inventors: Katsuhiko Kobayashi, Yamanashi (JP); Junya Tsuji, Kanagawa (JP); Yuki Kudo, Yamanashi (JP); Tatsuki Watanabe, Yamanashi (JP)

(21) Appl. No.: 13/421,220

(22) Filed: Mar. 15, 2012

(30) Foreign Application Priority Data
Mar. 15, 2011 (JP) 2011-056752

(51) Int. Cl. H01R 13/62; H01R 13/64

(52) U.S. Cl. 439/159; 439/374

(57) ABSTRACT

A card connector for receiving a card that is small and includes a card guide for guiding the card that will not deteriorate, even if the card is pulled out of or inserted into a card receiving space at a large tilt angle with respect to the card receiving space. The card connector having a housing, a plurality of contacts, a shell, and the card guide. The plurality of contacts arranged along the housing, while the shell covers the housing and provides a card receiving space between the housing and the shell. The card guide extends extending obliquely into the card receiving space from a top wall of the shell and is inclined at an acute angle with respect to the top wall.

### CROSS-REFERENCE TO RELATED APPLICATION

This application claims priority under 35 U.S.C. §119 to Japanese Patent Application No. 2011-056752, filed Mar. 15, 2011.

### FIELD OF THE INVENTION

The present invention relates to a connector and, more particularly, a card connector to which a card such as a memory card is connected.

### BACKGROUND

A known card connector is shown in JP 2005-353372 A, for connection to a card such as a memory card. The known card connector is provided with a housing for receiving a card, a plurality of contacts arranged in the housing, and a metal shell mounted on the housing and having a card receiving space between the metal shell and the bottom wall of the housing. In addition, the housing has an ejection mechanism of a so-called push-push type. The ejection mechanism is provided with a slider and a cam mechanism. The slider is used in abutting the leading end of the card and ejecting the card in a card-ejecting direction when being biased by a spring member. The cam mechanism is used for stopping the slider at a mating position and an ejecting position in the card-ejecting direction.

Then, in the known card connector provided with the ejection mechanism of this push-push type, when the slider is located at the ejecting position, the card is inserted. When the card is inserted, the front end of the card abuts against the slider. After that, when the back end of the card is further pushed, the slider advances and comes to the mating position, so that the card and the contact are electrically connected. Then insertion of the card is completed. When the card is ejected, the card is again pushed, but now pushed from the when the card insertion is completed. Subsequently, the function of the spring makes the slider recede to the ejecting position, and the card also recedes with the slider. The card can be removed from the known card connector by drawing the card backward from the known card connector.

Specifically, in order to prevent the card from dropping off unexpectedly at the ejecting position of the slider, a cutout is arranged at a side edge of the card and a lock member to be locked to the cutout is arranged along the slider.

It is to be noted that, however, the card to be inserted into or ejected from the known card connector described in JP 2005-353372 A is generally called mini-SD card. The size of the cutout is extremely small with respect to the card surface area. Hence, when the card is inserted or ejected, in particular, when the card is pulled out of the known card connector, there is a low chance of obliquely pulling out the card with respect to the known card connector. Even if the card is pulled out obliquely, with respect to the known card connector, the amount of tilt will be small. For this reason, although a card guide for guiding the card insertion and ejection is provided on the side portion of the housing, the thickness thereof can be made small and the dimension of the known card connector in the width direction can be made relatively small.

Meanwhile, in recent years, memory cards called micro-SD cards are widely used, and the size of the cutout of the micro-SD card is large with respect to the card surface area. Accordingly, when the card is inserted or ejected, in particular, when the card is pulled out of the known card connector, there is a high chance of pulling out the card obliquely with respect to the known card connector. Besides, when the card is pulled out obliquely with respect to the known card connector, the tilt amount will be large. For this reason, when a card guide for guiding the card insertion and ejection is provided on the side of the housing, the thickness thereof needs to be great and the dimension of the known card connector in the width direction cannot be made small.

To solve this issue, a solution shown in FIG. 10 is conceivable. FIG. 10A and FIG. 10B each are a schematic views showing a known card connector, in which a card guide for guiding the card is formed downward in a vertical direction with respect to the shell from a metal shell mounted above a housing. FIG. 10A shows when the card is inserted into and ejected from a card receiving space in a normal situation, and FIG. 10B shows when the card is inserted into and ejected from the card receiving space at a large tilt angle.

In the known card connector 101 for card shown in FIG. 10A and FIG. 10B, a card guide 122 for guiding insertion and ejection of a card C is formed downward in a vertical direction with respect to an upper wall 121 of a metal shell 120 from the shell 120 mounted on a housing 110. In this way, the card guide 122 is formed from the metal shell 120, so that the mechanical strength can be enhanced, the thickness can be reduced, and the dimension in the width direction of the known card connector 101 can be made small. Specifically, FIG. 10A and FIG. 10B show a bottom wall 111 of the housing 110, a lock member 130, and a hook portion 131.

It is to be noted that, however, the known card connector 101 shown in FIG. 10A and FIG. 10B has the following problems.

That is, as shown in FIG. 10A, when the card C is pulled out of the card receiving space 112 (toward the near side in the drawing) or inserted thereinto in a normal situation with respect to the card receiving space 112, the guide amount of the card guide 122 for guiding the card C is δ1, and this is relatively large.

On the other hand, when the card C is pulled out of the card receiving space 112 or inserted thereinto at a large tilt angle, the card C presses the card guide 122, as shown in FIG. 10B. As a result, the card guide 122 may bend outward with a fixed end thereof as a center and then tilts. Even if the card guide 122 is made of metal and has a high mechanical strength, such a event would occur. In this case, the card C would be easily pushed below the card guide 122, and the shell 120 would be lifted upward.

If the shell 120 is lifted upward, the guide amount of card guide 122 for guiding the card C would be δ2 that is smaller than δ1. Thus, the guide function of the card C for guiding the card guide 122 would further degrade.

### SUMMARY

Therefore, the present invention has been made in view of the above problems and has an objective, among others, to provide a card connector made small and that includes a card guide for guiding the card will not deteriorate, even if the card is pulled out of or inserted into a card receiving space at a large tilt angle with respect to the card receiving space.

The card connector having a housing, a plurality of contacts, a shell, and the card guide. The plurality of contacts arranged along the housing, while the shell covers the housing and provides a card receiving space between the housing and the shell. The card guide extends extending obliquely into the card receiving space from a top wall of the shell and is inclined at an acute angle with respect to the top wall.

### BRIEF DESCRIPTION OF THE DRAWINGS

The objects, features and advantages of the invention will become more apparent by describing in detail embodiments thereof with reference to the accompanying drawings, in which:

FIG. 1A is a plan view of a card connector according to the invention;

FIG. 1B is a front view of the card connector according to the invention;

FIG. 1C is a back view of the card connector according to the invention;

FIG. 2A is a right side view of the card connector of FIG. 1;

FIG. 2B is a left side view of the card connector of FIG. 1;

FIG. 2C is an enlarged view of a part indicated by an arrow 2C in FIG. 1B;

FIG. 2D is a cross-sectional view taken along line 2D-2D in FIG. 1A;

FIG. 3A is a plan view of the card connector of FIG. 1A in which a shell is removed;

FIG. 3B is a front view of the card connector of FIG. 1B in which the shell is removed;

FIG. 3C is a back view of the card connector of FIG. 1C in which the shell is removed;

FIG. 4A is a right side view of the card connector of FIG. 1A in which the shell is removed;

FIG. 4B is a left side view of the card connector of FIG. 1A in which the shell is removed;

FIG. 4C is an enlarged view of a part indicated by an arrow 4C in FIG. 3B;

FIG. 4D is a cross-sectional view taken along line 4D-4D in FIG. 3A;

FIG. 5A is a plan view of the card connector of FIG. 1A when a card is inserted into and a slider is located at an ejecting position;

FIG. 5B is a front view of the card connector of FIG. 1A when the card is inserted into and the slider is located at the ejecting position;

FIG. 5C is a back view of the card connector of FIG. 1A when the card is inserted into and the slider is located at the ejecting position;

FIG. 6A is a right side view of the card connector of FIG. 1A when the card is inserted into and the slider is located at the ejecting position;

FIG. 6B is a left side view of the card connector of FIG. 1A when the card is inserted into and the slider is located at the ejecting position;

FIG. 6C is a cross-sectional view taken along line 6C-6C in FIG. 5A;

FIG. 7 is a plan view of the card connector shown in FIG. 5A to FIG. 6C when the shell is removed;

FIG. 8 is a plan view of the card connector shown in FIG. 1A when the card is inserted into and pulled out of a card receiving space at a tilt angle;

FIG. 9A is a schematic view showing a card guide of the card connector, when the card is inserted into and pulled out of a card receiving space in a normal situation;

FIG. 9B is a schematic view of the card guide when the card is inserted into and pulled out of a card receiving space at a large tilt angle with respect to the card receiving space;

FIG. 10A is a schematic view a known card connector having a card guide that is formed downward and when the card is inserted into and pulled out of the card receiving space in a normal situation; and

FIG. 10B is a schematic view the known card connector with the card guide formed downward and when the card is inserted into and pulled out of the card receiving space at a large tilt angle.

### DETAILED DESCRIPTION OF THE EMBODIMENT(S)

Hereinafter, embodiments of a card connector according to the invention will be described with reference to the drawings.

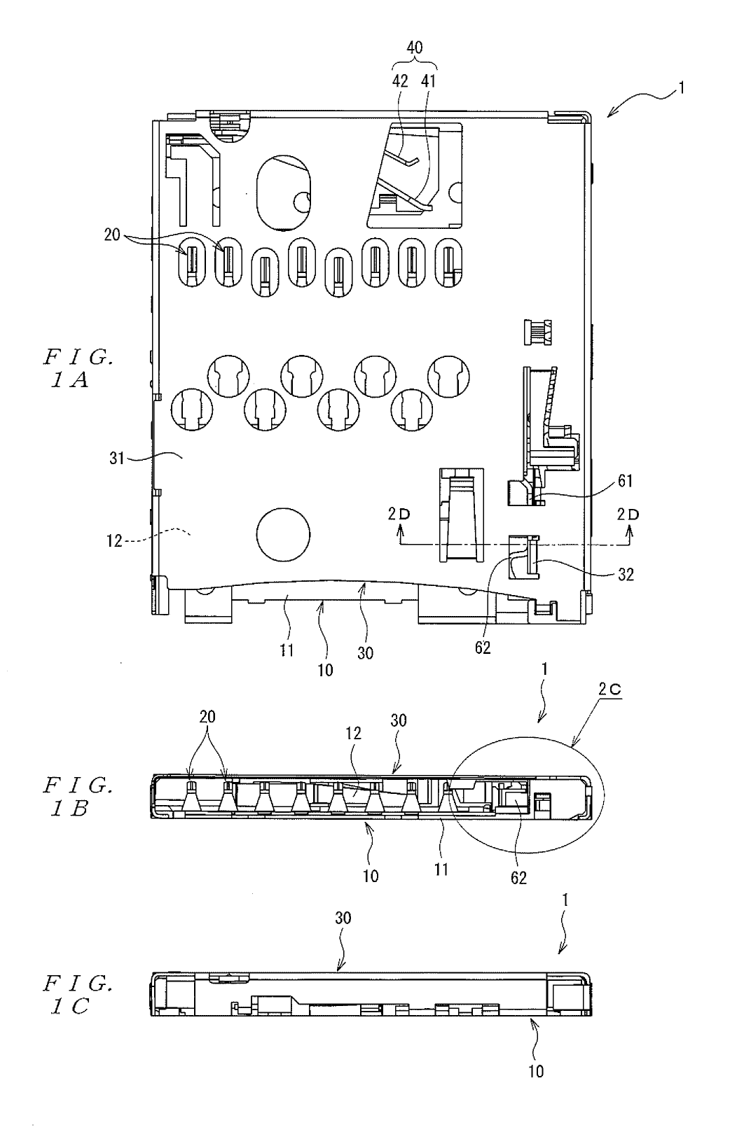

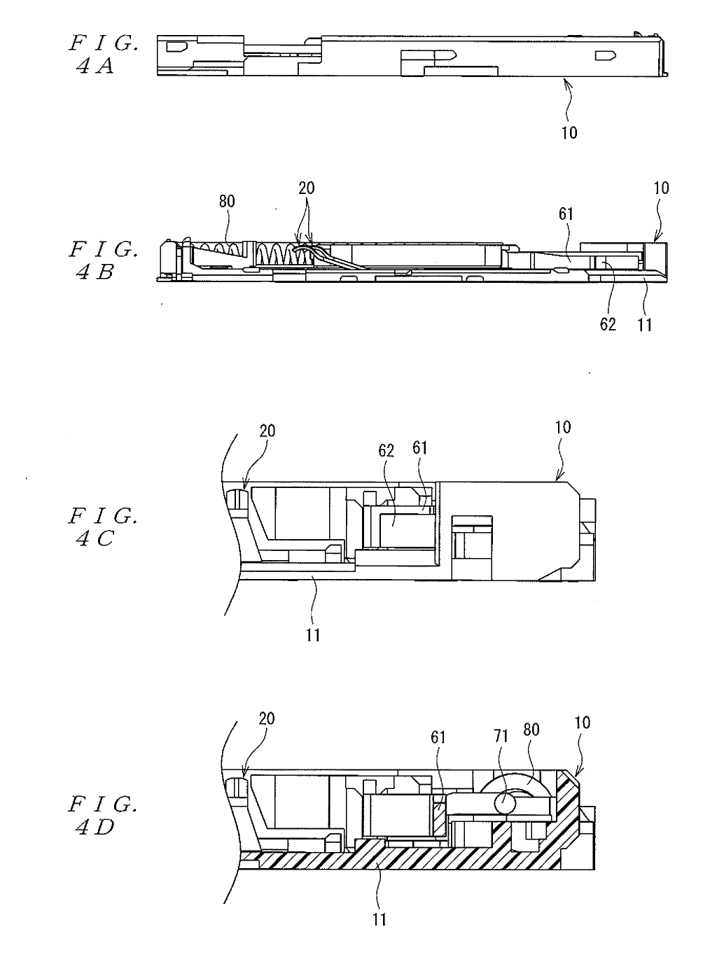

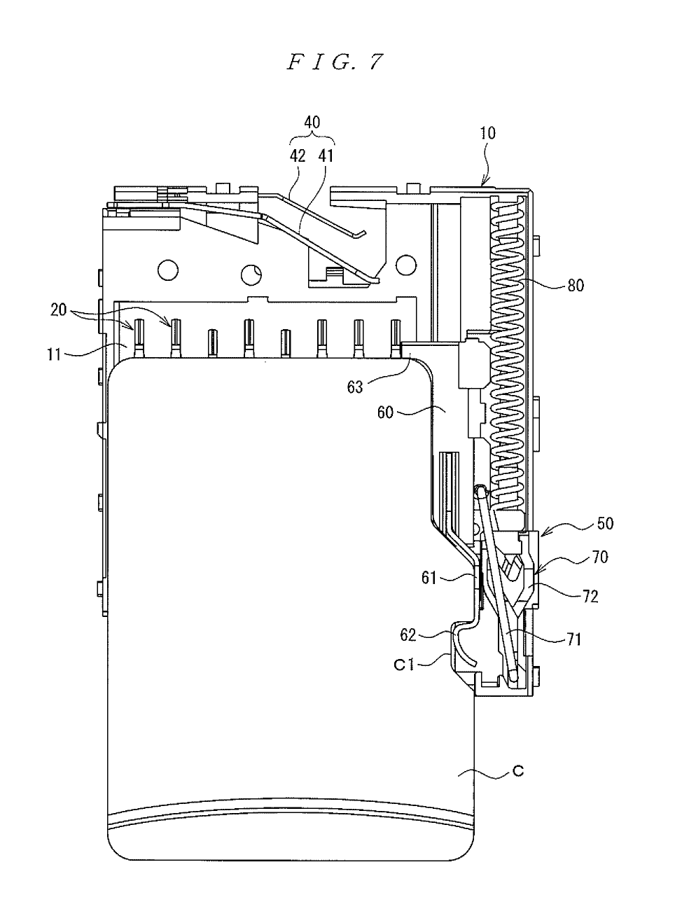

A card connector 1 shown in FIG. 1 to FIG. 6 is provided so that a card C (see FIG. 7) such as a memory card called micro-SD card is inserted thereinto and ejected there from. The card C is a substantially rectangular plate shape, and a cutout C1 is formed on one side edge of the card C, as shown from a right side edge in FIG. 7. The size of the cutout C1 is larger than that formed at a card called mini-SD card relative to a surface area of the card C. The card C is inserted from a front side to a back side with reference to the card connector 1.

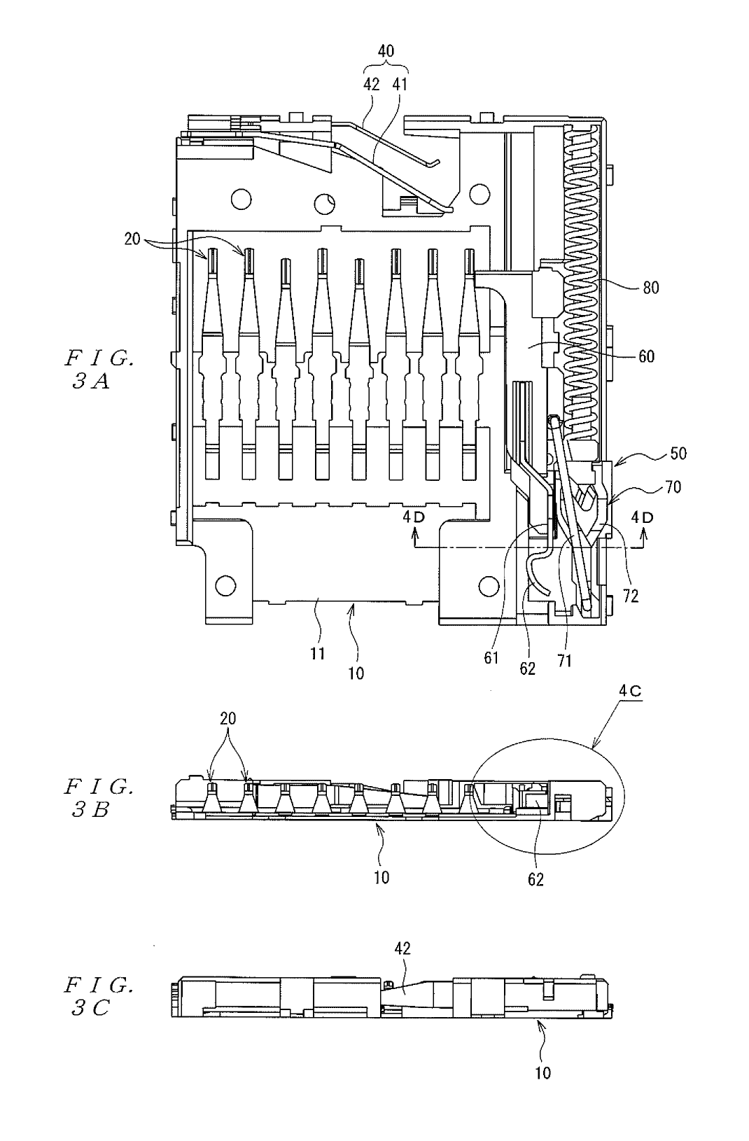

The card connector 1 is provided with a housing 10 for receiving the card therein, a plurality of contacts 20, a metal shell 30, a card detection switch mechanism 40, and an ejection mechanism of a push-push type (see FIG. 3A).

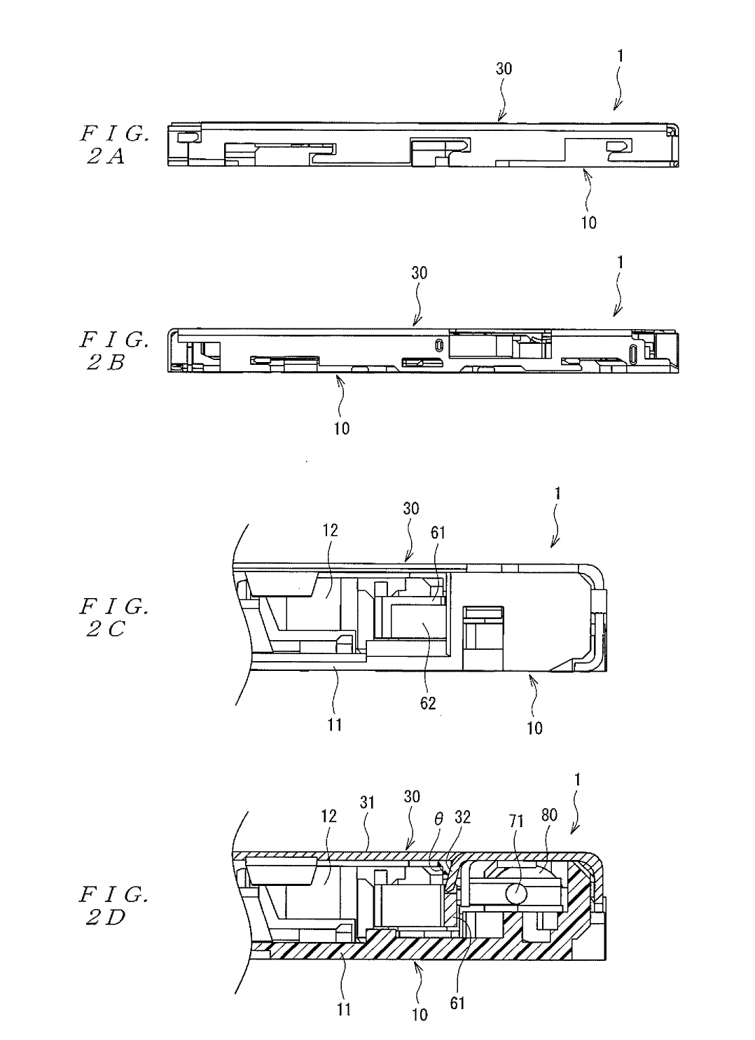

In the shown embodiment, the housing 10 has a substantially rectangular shape, and includes a card receiving space 12 for receiving the card C between the shell 30 installed from the upper side and a bottom wall 11, as shown in FIG. 1B, FIG. 2C, and FIG. 2D. The housing 10 is molded from an insulative synthetic resin.

Additionally, the plurality of contacts 20 are arranged in line, along a width of the housing 10 and along the bottom wall 11 of the housing 10 (see FIG. 3A). Each contact 20 is formed by stamping and forming a conductive metal sheet. A contact portion of each contact 20 protrudes into the card receiving space 12 for contact with a conductive pad (not shown) of the card C received by the card receiving space 12. A board connecting portion of each contact 20 extends downward in the housing 10 for connection to a printed circuit board, not shown.

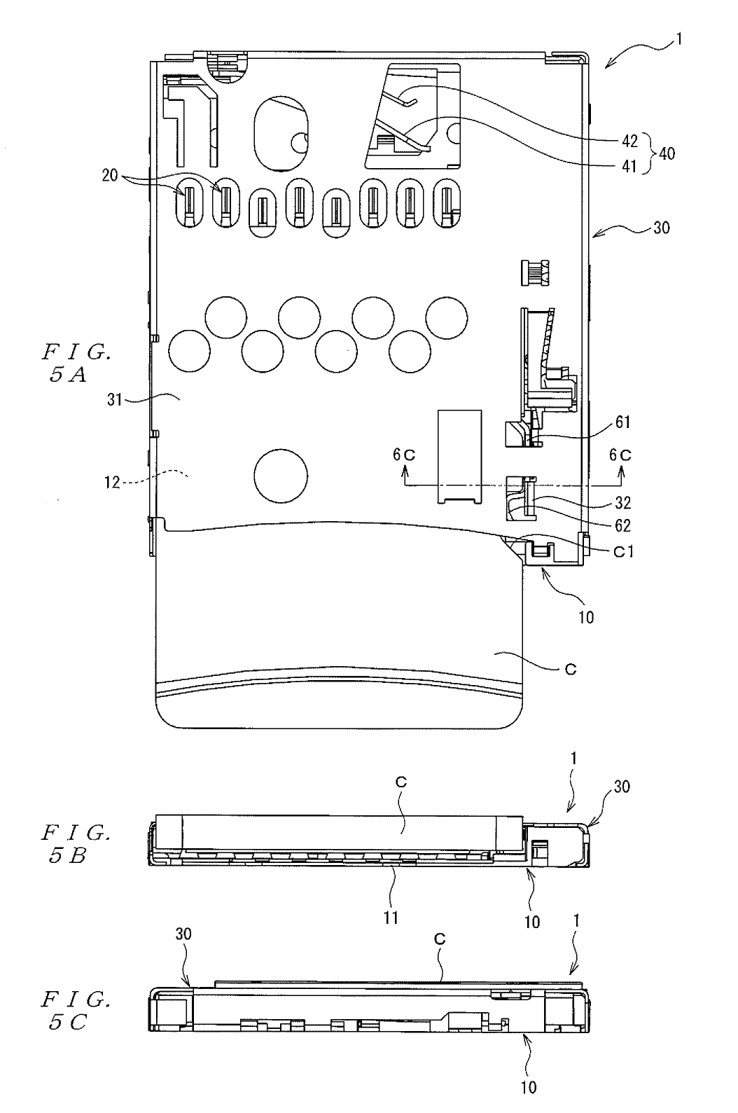

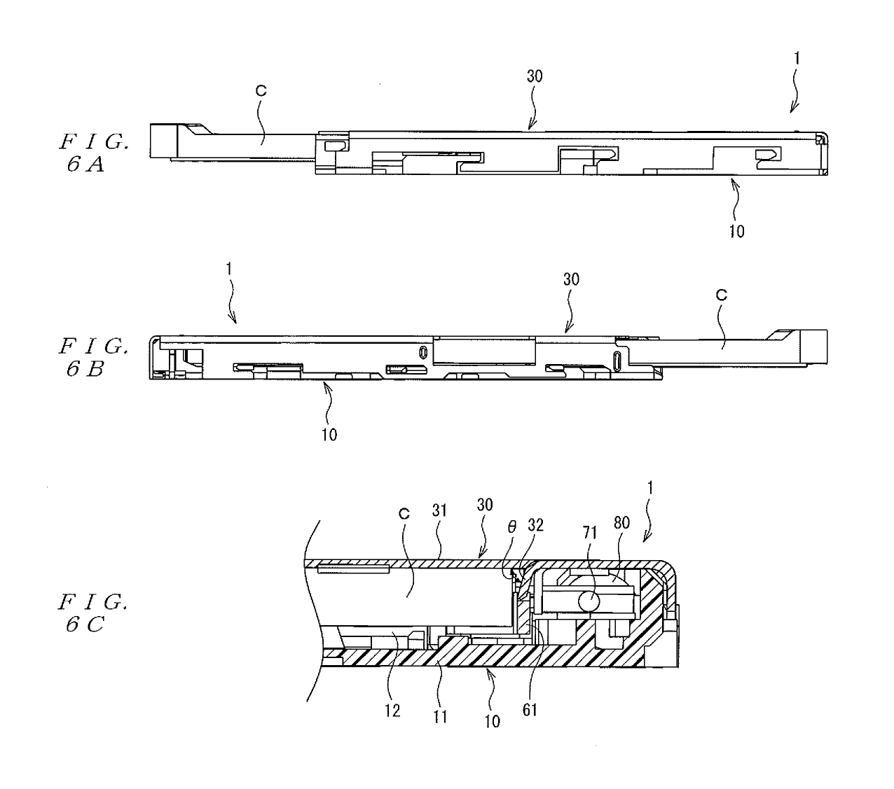

The metal shell 30 is formed by stamping and forming a metal sheet, and has a top wall 31 covering the top surface of the housing 10 and having a substantially flat plate shape. The shell 30 is mounted on the housing 10, and forms a card receiving space 12 between the shell 30 and a bottom wall 11 of the housing 10. Additionally, the shell 30 is secured to the housing 10 and includes side walls provided on both sides of the top wall 31 and a back wall is provided at a back end of the top wall 31. The shell 30 is provided with a card guide 32 for guiding the card C upon insertion and ejection of the card C, as shown in FIG. 1A, FIG. 2D, FIG. 5A, and FIG. 6C. The card guide 32 is arranged at a position in the vicinity of the front end of the shell 30 and in the vicinity of one side edge of the card receiving space 12, as shown in FIG. 1A and FIG. 2D. The card guide 32 is formed to have an acute angle with respect to the top wall 31 and extend obliquely into the card receiving space 12 from the top wall 31 of the shell 30, as shown in FIG. 2D and FIG. 6C. The term “acute angle” means an angle θ made by the top wall 31 of the shell 30 and the card guide 32, as shown in FIG. 2D. Preferably, the angle θ made by the top wall 31 of the shell 30 and the card guide 32 is 65 to 80 degrees. This is because if the angle θ is smaller than 65 degrees, the card guide 32 will easily get into the card C, whereas if the angle θ is larger than 80 degrees, the guide capability of guiding the card C will degrade. The functions of the card guide 32 will be described later in detail.

The card detection switch mechanism 40 is provided with a first terminal 41 made of metal and arranged at the back end of the housing 10, and a second terminal 42 made of metal arranged at the back end of the shell 30. The first terminal 41 and the second terminal 42 can be brought into contact with each other.

In the embodiments shown, the ejection mechanism 50 is a so-called push-push type, and is arranged along the housing 10 to eject the card C in a direction from back to front. Referring to FIG. 3A, the ejection mechanism 50 includes a slider 60 and a cam mechanism 70.

The slider 60 is disposed along one end side in the width direction of the housing 10, and is slidable from an ejecting position (see FIG. 3A and FIG. 5 to FIG. 7) to a pressing position (not illustrated), and then a mating position (not illustrated). The slider 60 is biased in the card-ejecting direction by the spring member 80 arranged between the housing 10 and the slider 60. The slider 60 is provided with a lock member 61 for being locked to the cutout C1 of the card C in order to prevent the card C from dropping off unexpectedly at the ejecting position of the slider 60. The lock member 61 is a resiliently deformable metal member, and is provided at an end thereof with a hook portion 62 having a curved shape for being locked to the cutout C1 of the card C. The lock member 61 is arranged along the slider 60 so that the hook portion 62 at its end is located on the front side of the slider 60, as shown in FIG. 3A. The hook portion 62 extends inward in the width direction from the end of the lock member 61, that is, extends toward the card receiving space 12. Then, the hook portion 62 of the lock member 61 is arranged below the card guide 32, as shown in FIG. 2C and FIG. 2D.

Additionally, the cam mechanism 70 includes a cam groove 72 having a heart shape in the embodiment shown, and a cam rod 71 moving along the cam groove 72, as shown in FIG. 3A. The cam groove 72 is arranged along the top surface of the slider 60. On the other hand, the cam rod 71 is also pivotally mounted on the housing 10 at the back end thereof, so that the front end of the cam rod 71 moves along the cam groove 72. In the embodiment shown, the cam rod 71 is formed by bending both ends of a linear shaped metal rod in the same direction.

Next, functions of the card guide 32 will be described with reference to FIG. 5 to FIG. 9.

Firstly, when the card C is not inserted into the housing 10, the slider 60 is located at the ejecting position as shown in FIG. 7. When the card C is inserted into the card receiving space 12, the leading end of the card C abuts against a protrusion 63 of the slider 60, as shown in FIG. 7, and the hook portion 62 of the lock member 61 locks with the cutout C1 of the card C, as shown in FIG. 5A and FIG. 7.

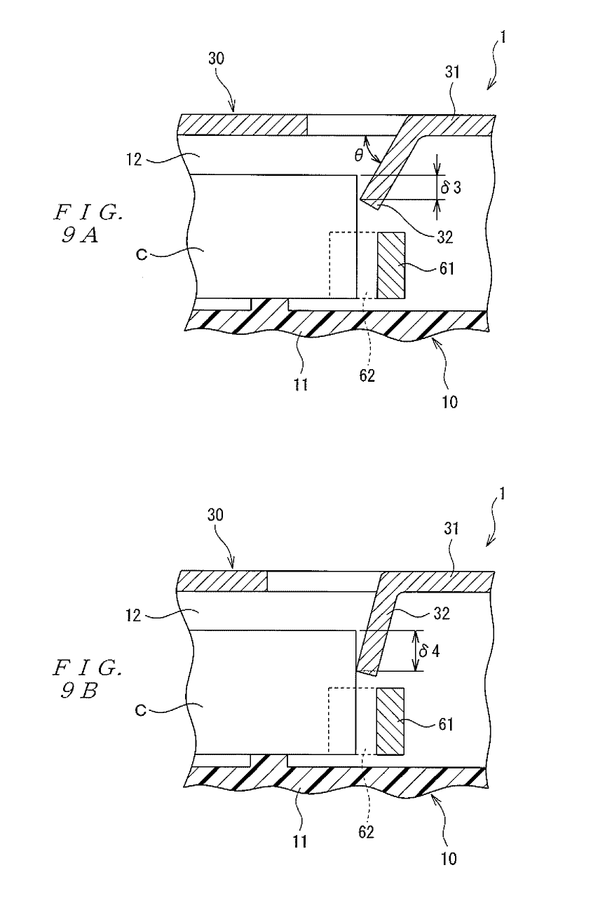

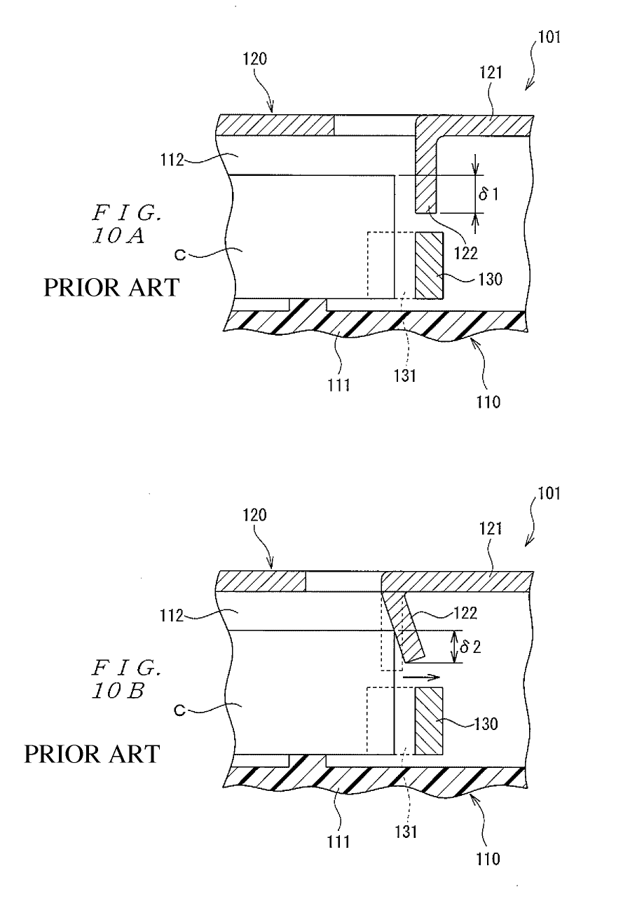

During insertion of the card C, the card C is guided by the card guide 32 arranged along one end side of the shell 30. Then, during insertion of the card C, as shown in FIG. 9A, the card C is inserted into the card receiving space 12 and the guide amount of the card guide 32 for guiding the card C is δ3 is relatively large.

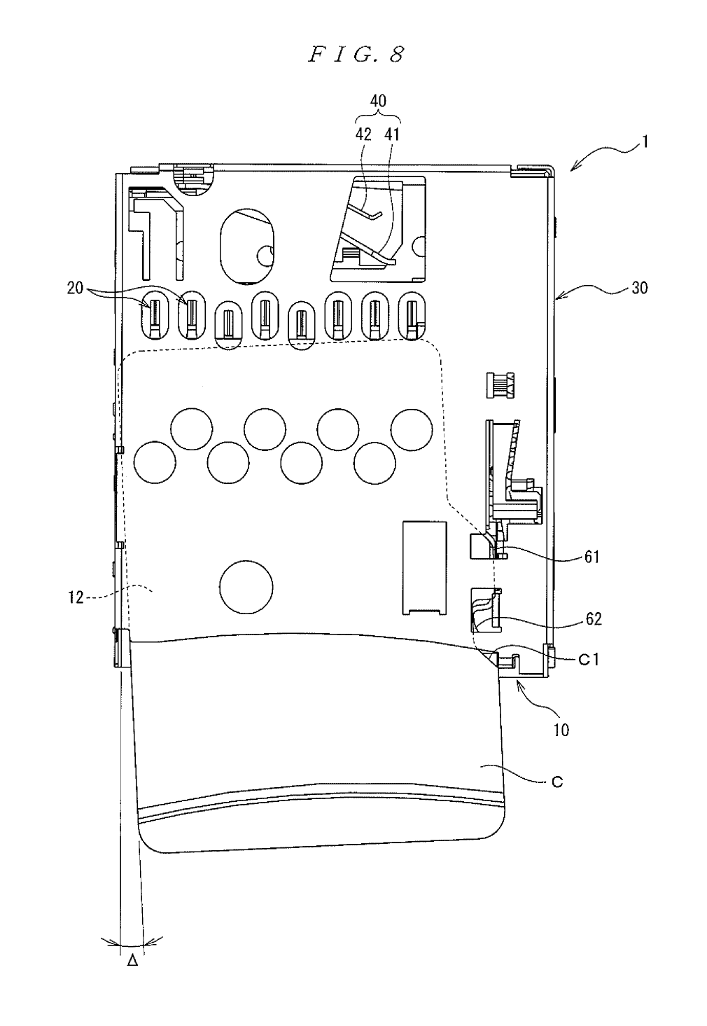

However, during insertion of the card C, as shown in FIG. 8, the card C may be inserted into the card receiving space 12 at a tilt angle with respect to the card receiving space 12. In FIG. 8, the tilt angle is indicated by A. In particular, since the size of the cutout C1 arranged at the card C is relatively large with respect to the surface area of the card C, the card C might be inserted into the card receiving space 12 at a large tilt angle. In this case, as shown in FIG. 9B, the lock member 61 is pressed by the card C and displaced outward in the width direction, and simultaneously, the card C presses the card guide 32. Hence, the card guide 32 bends outward in the width direction with the fixed end thereof as a center. In this situation, the card guide 32 is formed to have an acute angle with respect to the top wall 31 and extend obliquely into the card receiving space 12 from the top wall 31 of the shell 30. Therefore, the card guide 32 is pressed against the card C, to thereby exert a force of pressing down the shell 30. Accordingly, no force will be exerted that lifts the shell 30 upward. In addition, the guide amount of the card guide 32 for guiding the card C is increased to δ4. Thus, the guide capability of guiding the card C by the card guide 32 will not deteriorate.

Subsequently, insertion of the card C continues, and the slider 60 and the card C are made to advance until the slider 60 abuts against the back wall of the housing 10. Then, the slider 60 and the card C are located at the pressing position. In this state, when releasing the hand from the card C, the function of the spring member 80 biases the slider 60 in the card-ejecting direction (frontward), and the card C also moves together with the slider 60 in the card-ejecting direction and comes to the mating position. At this mating position, the insertion of the card C is completed, and the contact portion of the contact 20 makes contact with the conductive pad arranged on the bottom surface of the card C.

In contrast, when the card C is ejected, the card C is pressed again, so that the slider 60 and the card C are made to advance until the slider 60 abuts against the back wall of the housing 10. Then, the spring member 80 biases the slider 60 in the card-ejecting direction (frontward), and the card C also moves together with the slider 60 in the card-ejecting direction and comes to the ejecting position illustrated in FIG. 5 to FIG. 7. The card C is then repositioned out of the card receiving space 12, and it is thus possible to remove the card C.

Functions of the card guide 32 in the pulling operation of the card C are the same as those of the card guide 32 in the inserting operation of the card C. That is, in the pulling operation of the card C, as illustrated in FIG. 5A, FIG. 5B, and FIG. 6C, the card C is guided by the card guide 32. Additionally, in the pulling operation of the card C, as shown in FIG. 9A, when the card C is pulled out of the card receiving space 12 in a normal situation, the guide amount of the card guide 32 for guiding the card C is δ3, which is relatively large.

Meanwhile, in the pulling operation of the card C, the card C may be pulled out of the card receiving space 12 at a large tilt angle. In this case, as shown in FIG. 9B, the lock member 61 is pressed by the card C and displaced outward in the width direction, and simultaneously, the card C presses the card guide 32. Accordingly, the card guide 32 is curved outward in the width direction with the fixed end thereof as a center. In this situation, the card guide 32 is formed to have an acute angle with respect to the top wall 31 and extend obliquely into the card receiving space 12 from the top wall 31 of the shell 30. Therefore, the card guide 32 is pressed against the card C, to thereby exert a force of pressing down the shell 30. No force of lifting the shell 30 upward will be exerted. In addition, the guide amount of the card guide 32 for guiding the card C is increased to δ4. Accordingly, the guide capability of guiding the card C by the card guide 32 will not deteriorate. Since the card C is tilted more often in the pulling operation of the card C than in the inserting operation of the card C, there is an actual great advantage of forming the card guide 32 to have an acute angle with respect to the top wall 31.

In addition, as the card guide 32 is made of a metal shell 30 formed from the top wall 31, the card connector 1 has a higher mechanical strength and a smaller thickness and the width dimension of the card connector 1 can be reduced.

Furthermore, the lock member 61 for locking the card C is arranged below the card guide 32. It is therefore possible to make small the dimension in the width direction, when both of the card guide 32 and the lock member 61 are arranged in the card connector 1.

Heretofore, the embodiments of the invention have been described. However, the invention is not limited to them and various modifications and improvements may occur.

For example, the card C to be inserted into the card connector 1 is not limited to a memory card called micro-SD card, and any other type of memory card or SIM card may be applicable.

In addition, the lock member 61 may not necessarily be arranged below the card guide 32.

Although the exemplary embodiment of the invention has been disclosed for illustrative purposes, those skilled in the art will appreciate that various modifications, additions and substitutions are possible, without departing from the scope and spirit of the invention as disclosed in the accompanying claims.

What is claimed is:

1. A card connector comprising:
a housing;
a plurality of contacts disposed along the housing;
a shell covering the housing and providing a card receiving space between the housing and the shell; and
a card guide extending obliquely into the card receiving space from a top wall of the shell and inclined at an acute angle with respect to the top wall.

2. The card connector of claim 1, further comprising a card detection switch mechanism having a first terminal positioned at a back end of the housing.

3. The card connector of claim 2, wherein the card detection switch mechanism further includes a second terminal disposed at a back end of the shell.

4. The card connector of claim 3, wherein the first terminal and the second terminal are mateable with each other.

5. The card connector of claim 1, further comprising an ejection mechanism disposed along the housing.

6. The card connector of claim 5, wherein the ejection mechanism includes a slider and a cam mechanism.

7. The card connector of claim 6, wherein the slider is disposed along an end side of the housing and is biased by a spring member disposed between the housing and the slider.

8. The card connector of claim 7, wherein the slider is provided with a lock member having a hook portion.

9. The card connector of claim 8, wherein the lock member is disposed along the slider and the hook portion is located on a front side of the slider.

10. The card connector of claim 9, wherein the hook portion extends inward from an end of the lock member and extends toward the card receiving space.

11. The card connector of claim 10, wherein the hook portion is positioned below the card guide.

12. The card connector of claim 6, wherein the cam mechanism includes a cam groove positioned along a top surface of the slider and a cam rod moveable along the cam groove.

13. The card connector of claim 12, wherein the cam rod is pivotally mounted to the housing at a back end thereof.

14. The card connector of claim 13, wherein a front end of the cam rod moves along the cam groove.

15. The card connector of claim 1, wherein the plurality of contacts are disposed on a bottom wall of the housing and each of the plurality of contacts protrudes into the card receiving space.

16. The card connector of claim 1, wherein the metal shell includes a top wall covering a top surface of the housing and has a substantially flat plate shape.

17. The card connector of claim 1, wherein the shell includes side walls disposed on both sides of the top wall and a back wall provided at a back end of the top wall.

18. The card connector of claim 1, wherein the card guide is disposed along the front end of the shell and along a side edge of the card receiving space.

19. The card connector of claim 1, wherein the card guide forms acute angle with respect to the top wall and extends obliquely into the card receiving space from the top wall.

20. The card connector of claim 17, wherein the acute angle between the top wall and the card guide is between 65 and 80 degrees.
